(19) United States
(12) Patent Application Publication
(10) Pub. No.: US 2005/0181337 A1
(43) Pub. Date: Aug. 18, 2005

(54) Internet-based job safety analysis and job safety training and accountabilty method

(76) Inventor: Curt Shaw, Salem, OR (US)

Correspondence Address: JAMES E. PARRIS, P.O. BOX 233, HAILEY, ID, 83333, US

(21) Appl. No.: 10/772,131

(22) Filed: Feb. 3, 2004

(51) Int. Cl. G09B 19/00

(52) U.S. Cl. 434/219

(57) ABSTRACT

An internet-based job safety analysis and job safety training and accountability method for specifying jobs having job steps and job safety issues related to performing the job steps and having job safety requirements related to the job issues for enabling participants to select from web page options to create, use, edit, store, display and print job safety analysis and job training information located on a remote data storage system.

### FIELD OF THE INVENTION

The invention relates to internet-based job safety analysis and job safety training and accountability methods for enabling participants to select from web page options to create, use, edit, store, display and print job safety analysis and job training information located on a remote data storage system, where the data storage system may be customized by a user and shared between common organizations.

### BACKGROUND OF THE INVENTION

Job safety analysis and job safety training and accountability is important for many industries where worker safety and quality are an issue. Currently, organizations have entire departments dedicated to assuring worker safety and training, where such departments are tasked with evaluating work environments, assessing safety parameters, creating appropriate safety records and implementing safety programs. Safety problems arise with inadequate worker training for executing certain job steps such as handling dangerous materials, operating equipment or moving heavy items, to name a few. Further, when organizations with diverse job requirements and multiple facilities spread over vast geographic regions, a need exists for such organizations to have the ability to access a comprehensive job safety library for creating and implementing job safety analysis and job training and accountability methods in a cost effective and expedient manner. Garber, et al. (U.S. Pat. No. 5,752,054) teaches a system and method for developing and/or maintaining multiple workplace protection programs, however the method is limited in scope where a convenient library for access diverse job safety and training information is not available. Fletcher, et al. (U.S. Pat. No. 5,590,057) teaches a training and certification method that uses a comparative technology to quiz worker knowledge of safety issues. The system is difficult to customize for organizations having facilities spread over large geographic regions and a diversity of job tasks.

What is needed is a simple, cost-effective job safety analysis and job training and accountability method having access to a job safety library comprising job names, job steps, job issues and job requirements, using an internet medium, to enable organizations to create implement and use customized job safety analysis and job safety training and accountability methods and curriculums stored on a remote data storage system, where the data storage system can be customized by users and shared between common organizations.

### BRIEF DESCRIPTION OF DRAWINGS

FIG. 1 is an operating platform for the job safety analysis and job safety training and accountability method.

FIG. 2 is a log-in web page to a secure web site for the job safety analysis and job safety training and accountability method.

FIG. 3 is a main menu web page for the job safety analysis and job safety training and accountability method.

FIG. 4 is a blank job safety analysis and job safety training web page curriculum prompting a participant to select an existing job name or create a new job name.

FIG. 5 is an enter new job name web page for creating a new job name.

FIG. 6 is a new job safety analysis and job safety training curriculum web page enabling a participant to create, edit and use the current invention.

FIG. 7 is a web page enabling a participant to create a custom identification name for an existing job name.

FIG. 8 is a job safety analysis and job safety training web page having an updated job identification name.

FIG. 9 is an example of an existing job safety analysis and job safety training curriculum web page having an example job name “METAL WORK” and with related job steps, job issues and job requirements.

FIG. 10 is an add a job step web page prompting a participant to enter a job step “MATERIAL HANDLING”.

FIG. 11 is a job safety analysis and job safety training curriculum web page displaying an added job step “MATERIAL HANDLING” to a job step list.

FIG. 12 depicts a job safety analysis and job safety training curriculum web page with the selected example job step “MATERIAL HANDLING” having empty data fields for job issues and job requirements.

FIG. 13 depicts an add job issue web page for adding a job issue to a job issue list related to a selected job step.

FIG. 14 depicts a job safety analysis and job safety training curriculum web page having an added job issue to the job issue list.

FIG. 15 depicts an add job requirement web page for adding a job requirement to the job requirement list.

FIG. 16 depicts a job safety analysis and job safety training curriculum web page having an added job requirement to the job requirement list.

FIG. 17 depicts an edit job step web page.

FIG. 18 depicts an edit job issue web page.

FIG. 19 depicts an edit job requirement web page.

FIG. 20 depicts a blank job safety analysis and job safety training library web page prompting a participant to select a library job name.

FIG. 21 depicts a job safety analysis and job safety training library curriculum web page having library job steps, library job issues and library job requirements for selecting and copying to a job safety analysis and job safety training curriculum web page using a check/luncheck all box.

FIG. 22 depicts a job safety analysis and job safety training library web page having job steps, job issues and job requirements for selecting and copying to a job safety analysis and job safety training curriculum using a manual selection process.

FIG. 23 depicts a save job as web page.

FIG. 24 depicts a job safety analysis and job safety training specification form for use in portable data file pages, web page viewing and word processor documents.

FIG. 25 depicts a job safety analysis and job safety training performance evaluation document.

### DETAILED DESCRIPTION

The present invention comprises an internet-based job safety analysis and job safety training and accountability method, and more particularly, the invention is practical for defining jobs having job steps and job safety issues related to performing the job steps, and having job safety requirements related to resolving the job issues while performing the job steps. An administrator of the invention assigns user profiles to a plurality of participants to define user groups, where access parameters, comprising usernames and passwords, are established for using shared files in the data storage system common to the user groups.

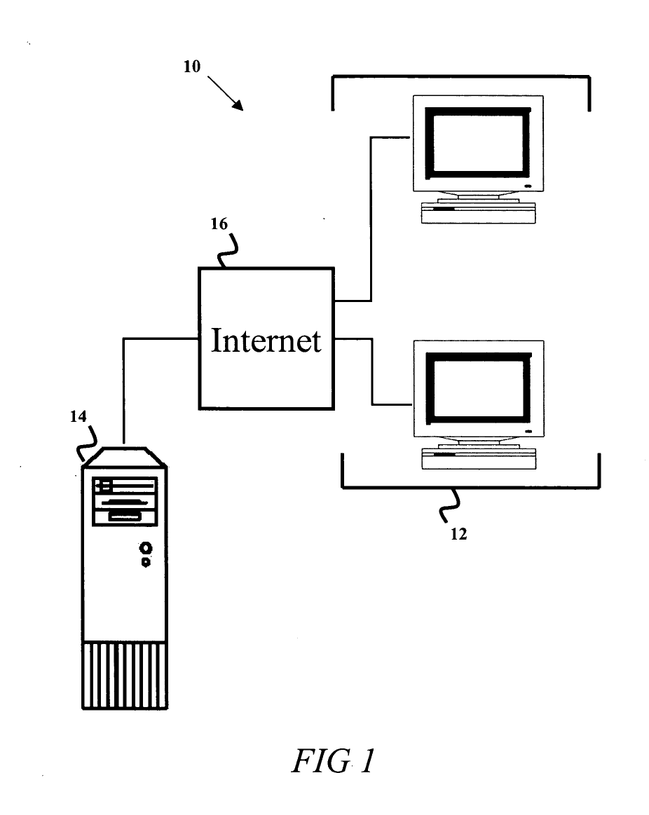

Referring now to the figures, FIG. 1 depicts an operating platform 10 for using a preferred embodiment of the invention. The operating platform comprises a plurality of computers 12 and data storage 14 system for operation with the internet 16. The data storage 14 system uses standard data storage system access methods such as open data storage system connectivity tools for accessing data storage system management systems such a structured query language for requesting information from the data storage system 14, enabling a plurality of users to access the same data storage system simultaneously.

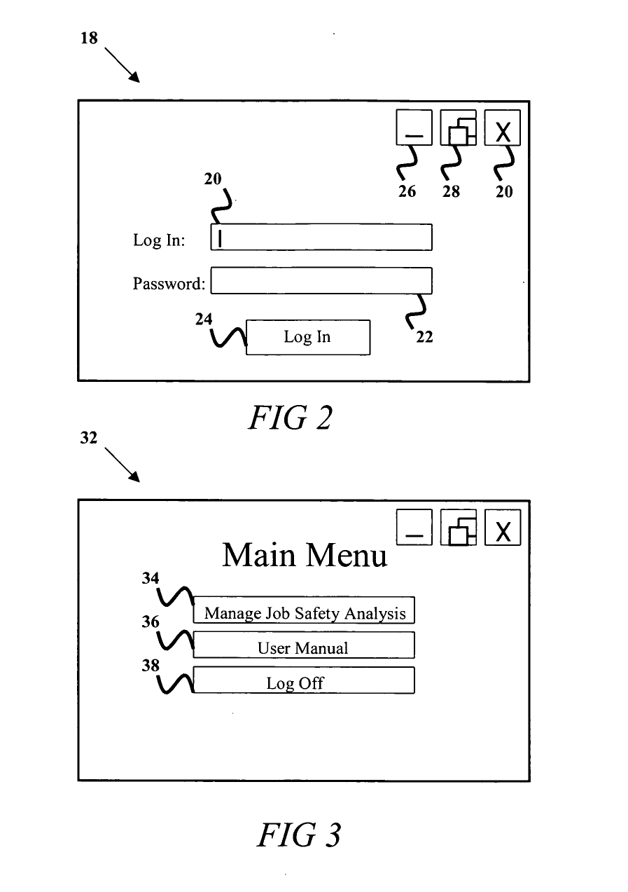

FIG. 2 depicts a predetermined secure web site 18 prompting a participant to log-in by entering a log-in name 20 and a secure password 22. The participant selects a log-in button 24 to access job safety analysis and job safety training and accountability invention web pages depicted in the following drawing and discussion. The secure web site 18 and all subsequent web pages discussed below have options to minimize 26, maximize/reduce 28 and close 32 the secure web site 18 window and web pages.

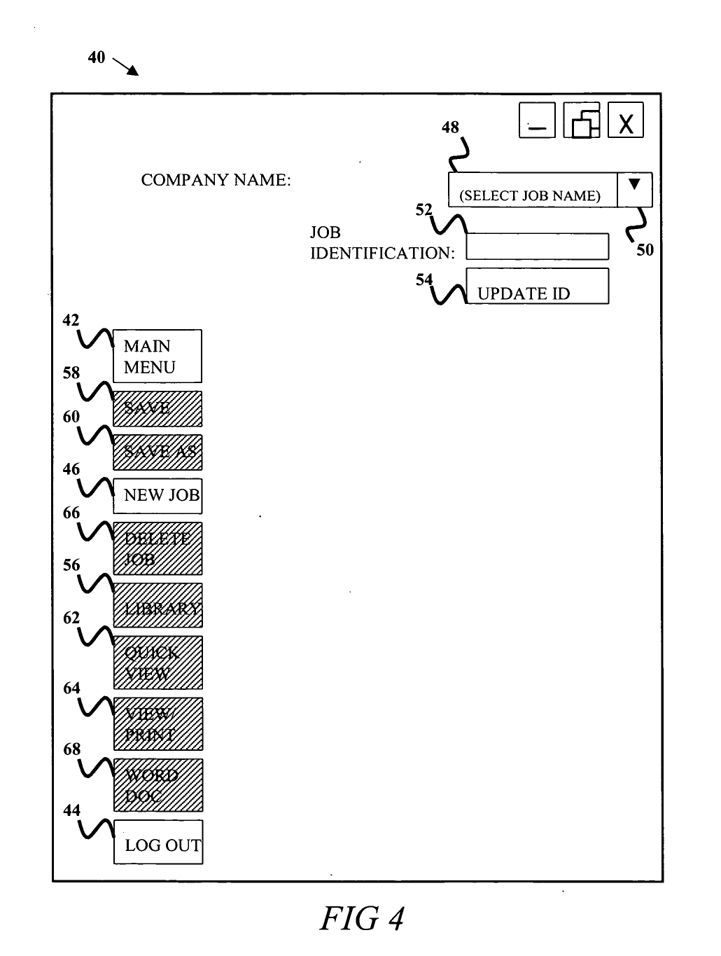

Upon successful log-in by the participant, the secure web site 18 displays a main menu web page 32, as depicted in FIG. 3. Here, the main menu web page 32 has options comprising manage job safety analysis 34, access user manual 36, and log off 38, wherein selecting the log off option 38 terminates access to the secure web site 18. Further depicted in FIG. 3, the participant may select the user manual option 36 to display a web page providing the participant instructions (not shown) for operating the job safety analysis and job safety training and accountability invention. Selecting the manage job safety analysis option 34 enables the participant to access a blank job safety analysis and job safety training curriculum web page 40, depicted in FIG. 4, having options that enable the participant to create, use, edit, store, display and print job safety analysis and job safety training information located on the remote data storage 14 system.

FIG. 4 depicts a blank job safety analysis and job safety training curriculum web page 40 having active options to enable the participant to return to the main menu 42, log-out 44 and create a new job 46. Further depicted are options for the participant to select a job name 48 from a job name drop-down list 50 having a blank identification name 52 and an update a job identification name option 54 where the identification name is alphanumeric. The blank job safety analysis and job safety training curriculum web page 40 further displays temporarily inactive menu options to enter a library 56, save job 58, save job as 60, quick view 62, view/print 64, delete job 66 and view in word processor document 68, wherein selecting the return to main menu option 42 displays the main menu web page 32 and selecting the log-out option 44 terminates access to the invention and returns the participant to the secure web site web page 18 prompting the participant to log-in using a user name 20 and password 22. The inactive options are depicted as having hatch marks to designate as temporarily inactive where these options remain inactive until either a new job name has been created by selecting the create new job option 46, or until an existing job name 48 has been selected from the job name drop-down list 50.

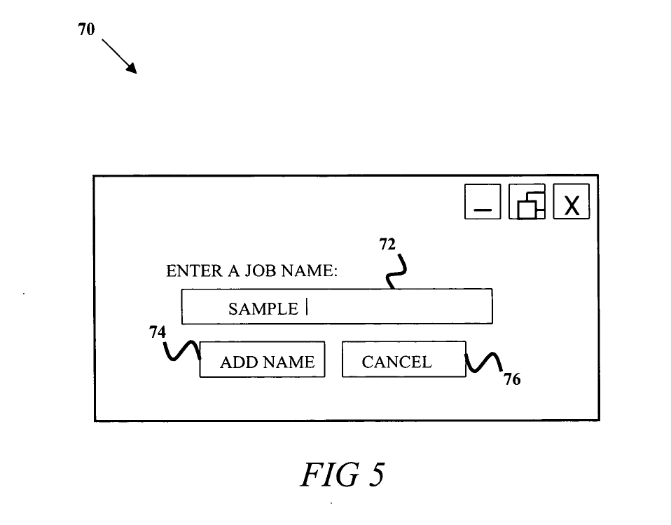

As the participant selects the create a new job option 46, the secure web site 18 displays a create new job web page 70 as depicted in FIG. 5. The participant is prompted to enter a new job name 72 and select an add job name option 74 or select a cancel new job name option 76. In this example, the new job name “SAMPLE” is used for illustration. The participant may select the cancel new job name option 76 to close the add new job name web page 70 without adding a new job name 48 to the job name drop-down list 50.

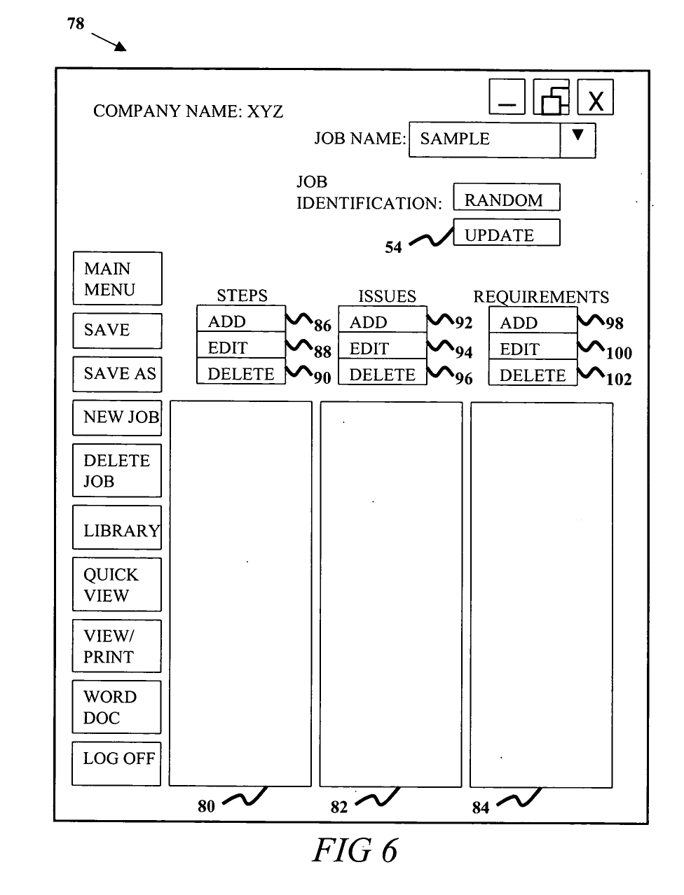

FIG. 6 depicts a new job safety analysis and job training and accountability curriculum web page 78, having a job name 48 titled SAMPLE, resulting from the participant selecting the add new job name option 74 or FIG. 5 and entering SAMPLE as a job name 48. The new job safety analysis and job training and accountability curriculum web page 78, resulting from the add new job name process described above, has empty data fields for a job step list 80, a job issue list 82 and a job requirement list 84. Additional new options appear on the new job safety analysis and job safety training curriculum web page 78 comprising add job step 86, edit job step 88, delete job step 90, add job issue 92, edit job issue 94, delete job issue 96, add job requirement 98, edit job requirement 100 and delete job requirement 102. Further, the inactive options of the blank job safety analysis and job training and accountability curriculum web page 40 of FIG. 4 are activated and are depicted without having the hatch marks of FIG. 4, to indicate the options as being active options for use. The participant uses the menu items of new job safety analysis and job training and accountability curriculum web page 78 to create, edit, store and use the custom job safety analysis and job safety training invention.

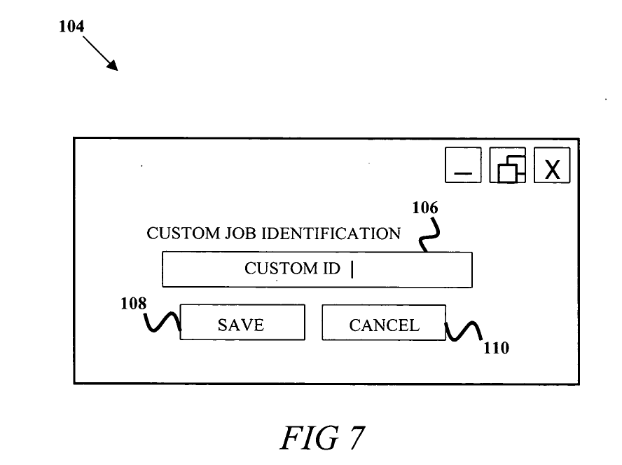

The participant may select the update job identification name option 54 depicted in FIG. 6, where the secure web site displays a custom job identification name web page 104, as depicted in FIG. 7. In FIG. 7, the participant is prompted to enter a custom job identification name 106 and select a save custom job identification name option 108 to store the custom job identification name 106 in the remote data storage 14 system and display the new custom job identification name 106 on the new job safety analysis and job training and accountability curriculum web page 78. Alternatively, the participant may select a cancel custom job identification name option 110 to close the custom job identification name web page 104 without creating a custom identification name. In this example, the custom job identification name “CUSTOM ID” is used for illustration. The job identification name 52, be it custom or generated automatically by the job safety analysis and job safety training invention, is for use by the participant and does not affect the address of a job safety analysis and job safety training curriculum web page in the remote data storage 14 system.

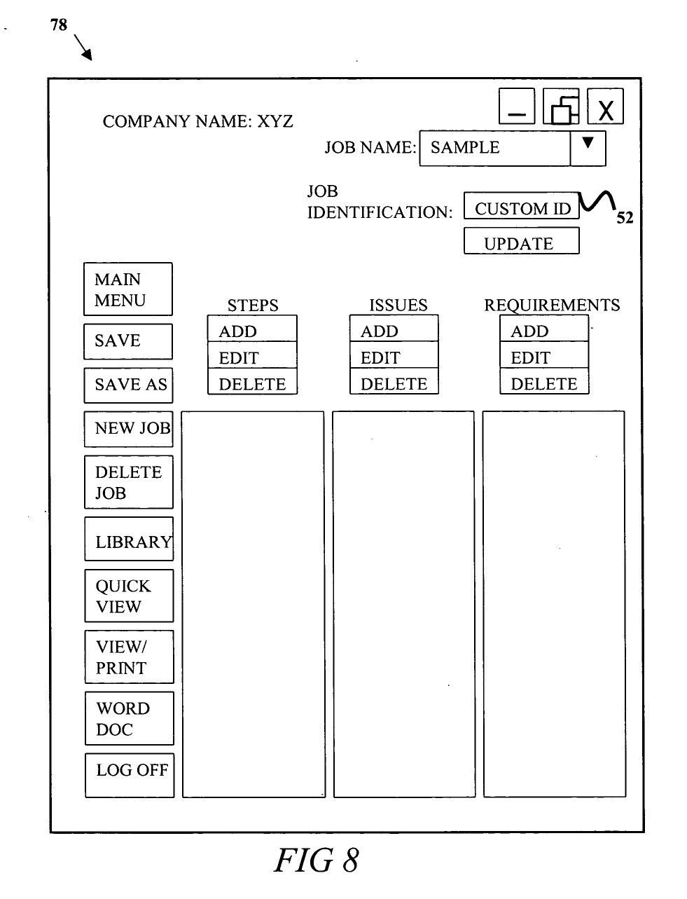

FIG. 8 depicts the new job safety analysis and job safety training and accountability curriculum web page 78 having the updated job identification name 52 CUSTOM ID displayed as the job identification name 52. The job Identification name 52 is an alphanumeric set.

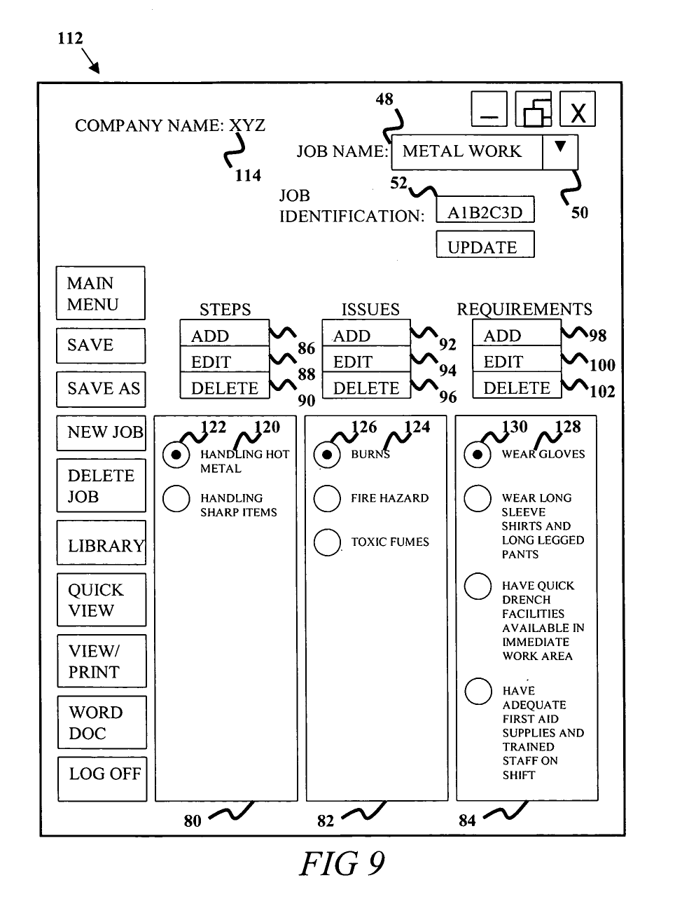

Referring now to FIG. 9, the participant may select a job name 48 from the job name drop-down list 50 to display an existing job safety analysis and job safety training and accountability curriculum web page 112 having a job identification name 52 associated with the job name 48, where the participant may modify the job identification as described above if so desired. In this example, the existing job name 48 “METAL WORK” located in a remote data storage 14 system and having preloaded job steps 120, job issues 124 and job requirements 128 is used for illustration. Each existing job safety analysis and job safety training and accountability curriculum web page 112 is saved as a separate file in the remote data storage 14 system. When the existing job safety analysis and job safety training and accountability curriculum web page 112 is referenced, the job details of the selected job name 48 comprising, a job step list 80, a job issue list 82 and a job requirement list 84 which are unique to the selected job name 48 and are pre loaded in the remote data storage 14 system are displayed. The job steps 120 have associated job step activation buttons 122, the job issues 124 have associated job issue activation buttons 126 and the job requirements 128 have associated job requirement activation buttons 130 to selectively enable/disable the job steps 120, job issues 124 and job requirements 128 for an action respectively. The first job step 120, job issue. 124 and job requirement 128 in the respective lists are enabled by default, using the activation buttons, and only one activation button in a list may be enabled at one time. More specifically, when a job step activation button 122 is enabled, the existing job safety analysis and job training and accountability curriculum web page 112 displays the associate job issues 124 in the job issue list 82 and displays the associated job issue activation buttons 126 stored in the remote data storage 14 system. The first job issue activation button. 126 associated to the first job issue 124 in the job issue list 82 is enabled by default, and only one activation button in the job issue list 82 may be enabled at any one time. When a job issue activation button 126 is enabled, the existing job safety analysis and job training and accountability curriculum web page 112 displays the associate job requirements 128 having job requirement activation buttons 130 in the associated job requirement list 84 stored in the remote data storage 14 system. The first job requirement activation button 130 associated with the first job requirement 128 in the job requirement list 84 is enabled by default, and only one job requirement activation button 130 in the job requirement list 84 may be enabled at any one time.

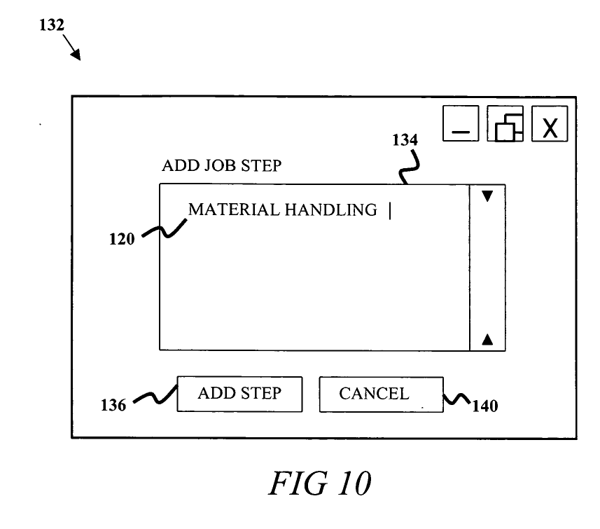

The participant may add his own content to the job step list 80, job issue list 82 and job requirement list 84. More particularly, the participant may add a job step to the job step lists 80 of FIGS. 6, 8 or 9 by selecting the add job step option 86. For illustrative purposes, the participant adds a job step 120 to the job step list 80 of the METAL WORK job name 48 in FIG. 9 by selecting the add job step option 86, whereby the secure web site 18 displays an add job step web page 132, as depicted in FIG. 10. The add job step web page 132 displays an add job step prompt 134 for the participant to enter a job step 120 and select an add job step option 136 to display the added job step 120 in the job step list 80, or the participant may select a cancel add job step option 140 to close the add job step web page 132 without adding a new job step 120 to the job step list 80.

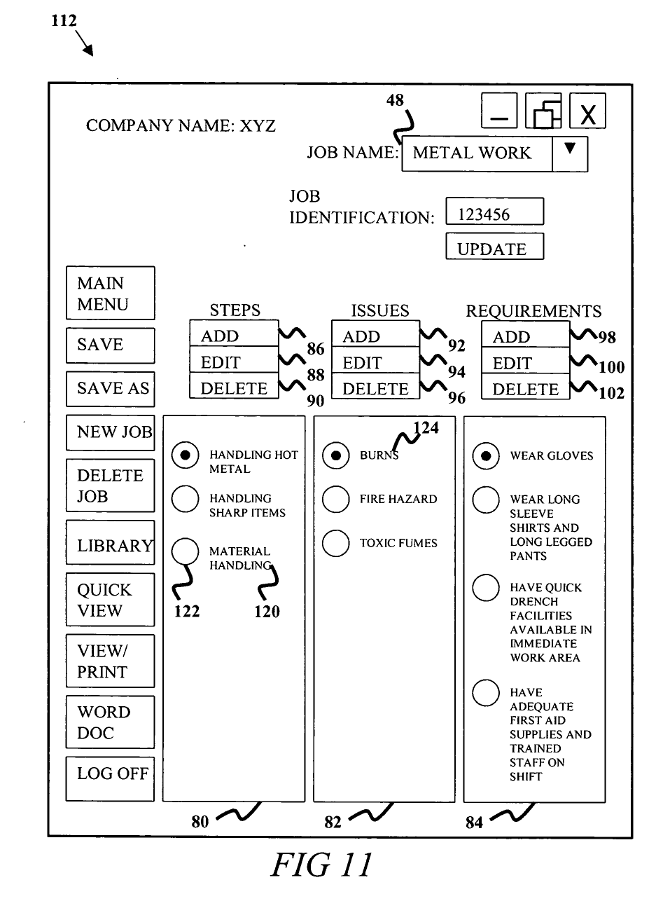

In this example, the job step 120 “MATERIAL HANDLING” is added to the job step list 80 for illustration. In FIG. 10, the participant selects the option to add step 136, whereby the add job step web page 132 closes and the job step 120 MATERIAL HANDLING is displayed in the job step list 80 having a job step activation button 122, as depicted in FIG. 11. The job step 120 MATERIAL HANDLING will not have associated job issues 124 or job requirements 128 in their respective job issue list 82 and job requirement list 84 until expressly added or assigned.

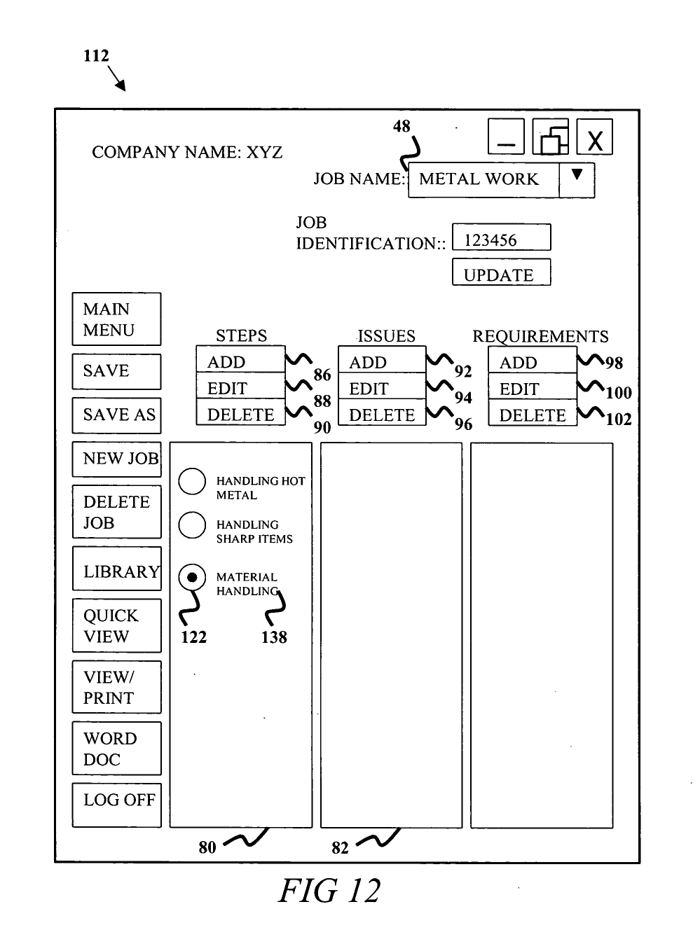

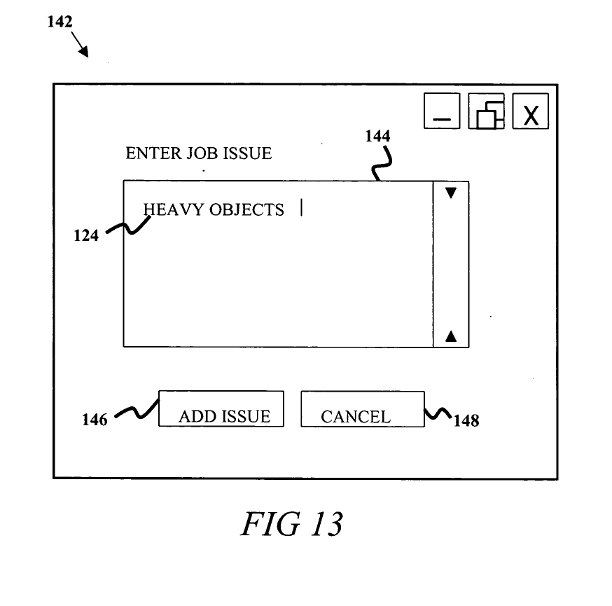

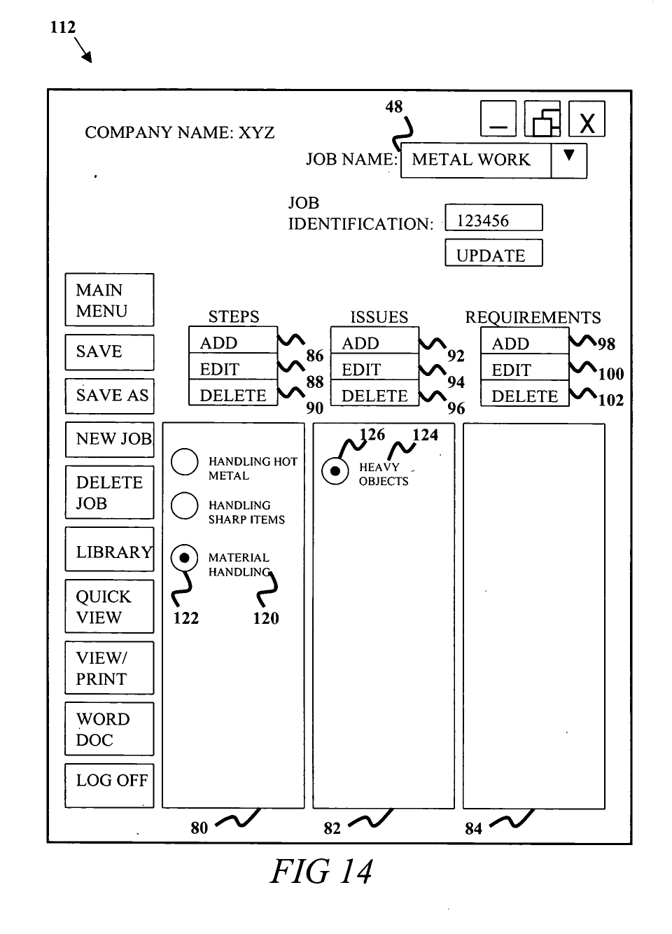

The participant may add a job issue 124 to the job issue list 82 of FIGS. 6, 8, 9 or 11. Referring now to FIG. 12, the participant adds a job issue 124 to the job issue list 82 of the existing job safety analysis and job safety training curriculum web page 112 having the METAL WORK job name 48 by selecting a job step activation button 122 associated with a desired job step 120, to display a desired job issue list 82 for adding a job issue 124 thereto. In this example the participant selects the job step activation button 122 associated with the job step 120 MATERIAL HANDLING to display the associated job issue list 82 for adding a job issue 124 thereto, wherein the job issue list 82 associated with the job step 12 MATERIAL HANDLING is an empty field in this example. The participant then selects the add job issue 92 option, whereby the secure web site 18 displays an add job issue web page 142, as depicted in FIG. 13. The add job issue web page 142 displays an enter job issue prompt 144 for the participant to enter a job issue 124 and select an accept job issue 146 option to display the added job issue 124 in the job issue list 82, or the participant may select a cancel add job issue option 148 to close the add job issue web page 142 without adding a job issue 124 to the job issue list 82. In this example, the job issue 124 “HEAVY OBJECTS” is added to the job issue list 82 for illustration. In FIG., 13, the participant selects the option to add issue 146, whereby the add job issue web page 142 closes and the job issue 124 HEAVY OBJECTS is displayed in the job issue list 82 having a job issue activation button 126, as depicted in FIG. 14. The job issue 124 HEAVY OBJECTS will not have associated job requirements 128 in the job requirement list 84 until expressly added or assigned.

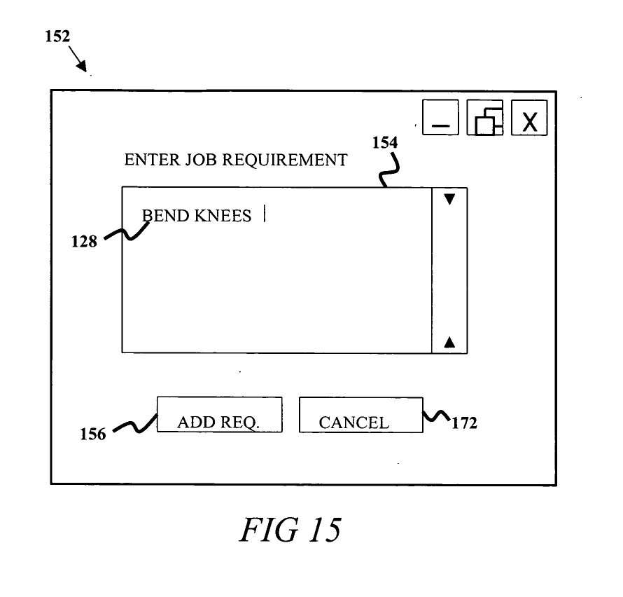

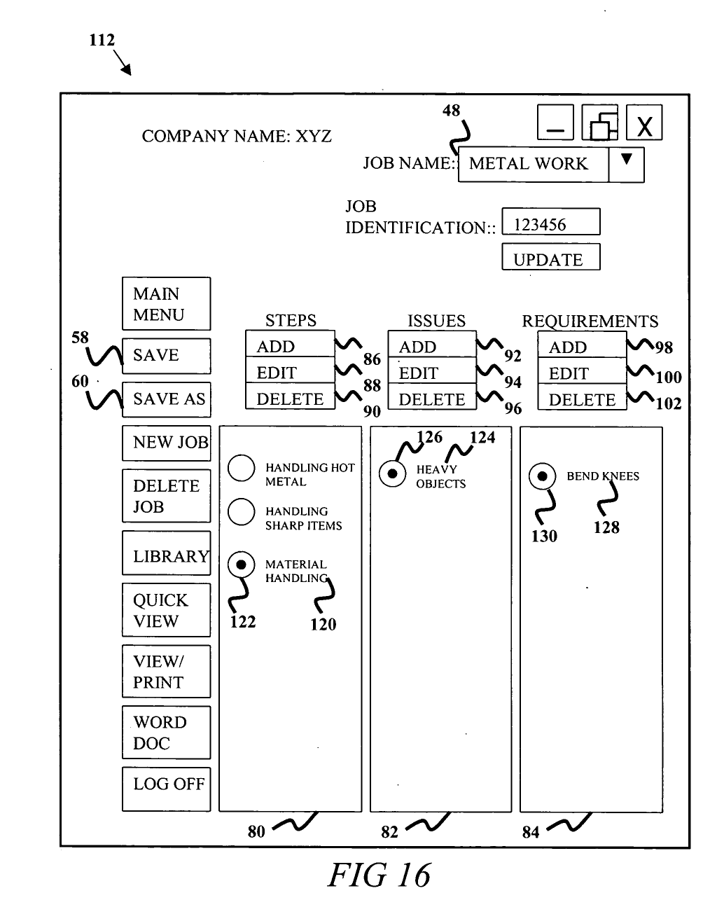

The participant may add a job requirement 128 to the job requirement list 84 of FIGS. 6, 8, 9, 11, or 14. Referring now to FIG. 14, the participant adds a job requirement 128 to the job requirement list 84 of the existing job safety analysis and job safety training and accountability curriculum web page 112 having METAL WORK job name 48 by selecting a job issue activation button 126 associated with a desired job issue 124, to display a desired job requirement list 84 for adding a job requirement 128 thereto. In this example the participant selects the job issue activation button 126 associated with the job issue 124 HEAVY OBJECTS to display the associated job requirement list 84 for adding a job requirement 128 thereto, wherein the job requirement list 84 associated with the job issue 124 HEAVY OBJECTS is an empty field in this example. The participant then selects the add job requirement 98 option, whereby the secure web site 18 displays an add job requirement web page 152, as depicted in FIG. 15. The add job requirement web page 152 displays an enter job requirement prompt 154 for the participant to enter a job requirement 128 and select an accept job requirement 156 option to display the add job requirement 128 in the job requirement list 84, or the participant may select a cancel add job requirement option 172 to close the add job requirement web page 152 without adding a job requirement 128 to the job requirement list 84. In this example, the job requirement 128 “BEND KNEES” is added to the job requirement list 84 for illustration. In FIG. 15, the participant selects the option to add requirement 156, whereby the add job requirement web page 152 closes and the job requirement 128 BEND KNEES is displayed in the job requirement list 84 having a job requirement activation button 130, as depicted in FIG. 16. The job requirement 128 BEND KNEES is associated with the job issue 124 HEAVY OBJECTS, and the job issue 124 HEAVY OBJECTS is associated with the job step 120 MATERIAL HANDLING.

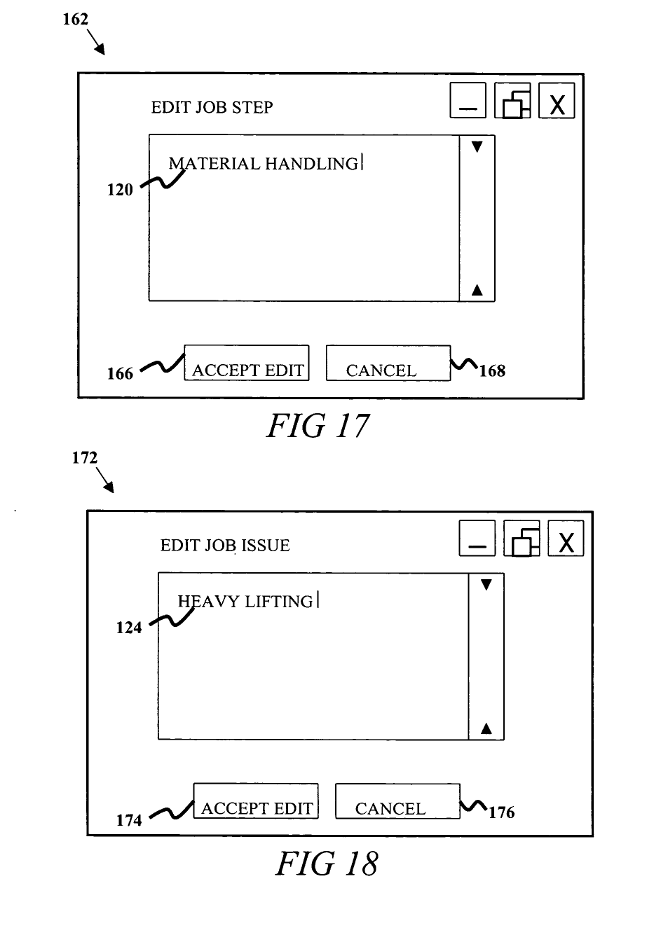

The participant may edit a job step 120 in the job step list 80 by selecting a job step activation button 122 associated with the desired job step 120, then selecting the edit job step option 88, whereby an edit job step web page 162 is displayed as depicted in FIG. 17. The edit job step web page 162 displays the selected job step 120 to be edited and prompts the participant to make changes to the selected job step 120. The participant may select an option to accept job step changes 166, whereby the edited job step 120 is displayed in the job step list 80, or the participant may select an option to cancel the job step edit 168, whereby the edit job step web page 162 closes without making changes to the job step 120.

The participant may edit a job issue 124 in the job issue list 82 by selecting a job issue activation button 126 associated with the desired job issue 124, then selecting the edit job issue option 94, whereby an edit job issue web page 172 is displayed as depicted in FIG. 18. The edit job issue web page 172 displays the selected job issue 124 to be edited and prompts the participant to make changes to the selected job issue 124. The participant may select an option to accept job issue changes 174, whereby the edited job issue 124 is displayed in the job issue list 82, or the participant may select an option to cancel the job issue edit 176, whereby the edit job issue web page 172 closes without making changes to the job issue 124.

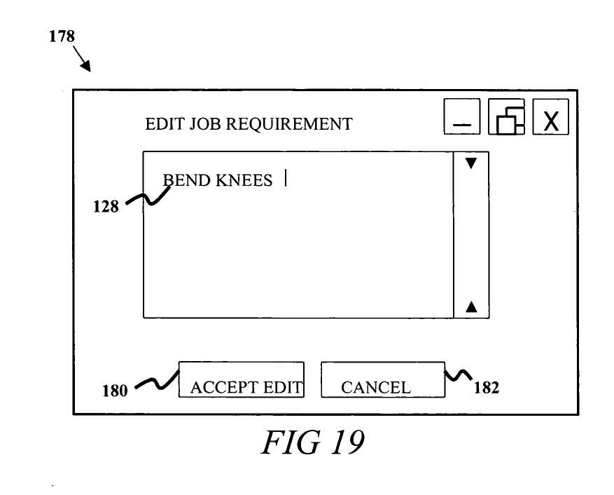

The participant may edit a job requirement 128 in the job requirement list 84 by selecting a job requirement activation button 130 associated with the desired job requirement 128, then selecting the edit job requirement option 100, whereby an edit job requirement web page 178 is displayed, as depicted in FIG. 19. The edit job requirement web page 178 displays the selected job requirement 128 to be edited and prompts the participant to make changes to the selected job requirement 128. The participant may select an option to accept job requirement changes 180, whereby the edited job requirement 128 is displayed in the job requirement list 84, or the participant may select an option to cancel the job requirement edit 182, whereby the edit job requirement web page 178 closes without making changes to the job requirement 128.

The participant may delete a job step 120 in the job step list 80 by selecting a job step activation button 122 associated with the desired job step 120 to be deleted, then selecting the delete a job step option 90, whereby the selected job step 120 is deleted from the job step list 80.

The participant may delete a job issue 124 in the job issue list 82 by selecting a job issue activation button 126 associated with the desired job issue 124 to be deleted, then selecting the delete a job issue option 96, whereby the selected job issue 124 is deleted from the job issue list 82.

The participant may delete a job requirement 128 in the job requirement list 84 by selecting a job requirement activation button 130 associated with the desired job requirement 128 to be deleted then selecting the delete a job requirement option 102, whereby the selected job requirement 128 is deleted from the job requirement list 84.

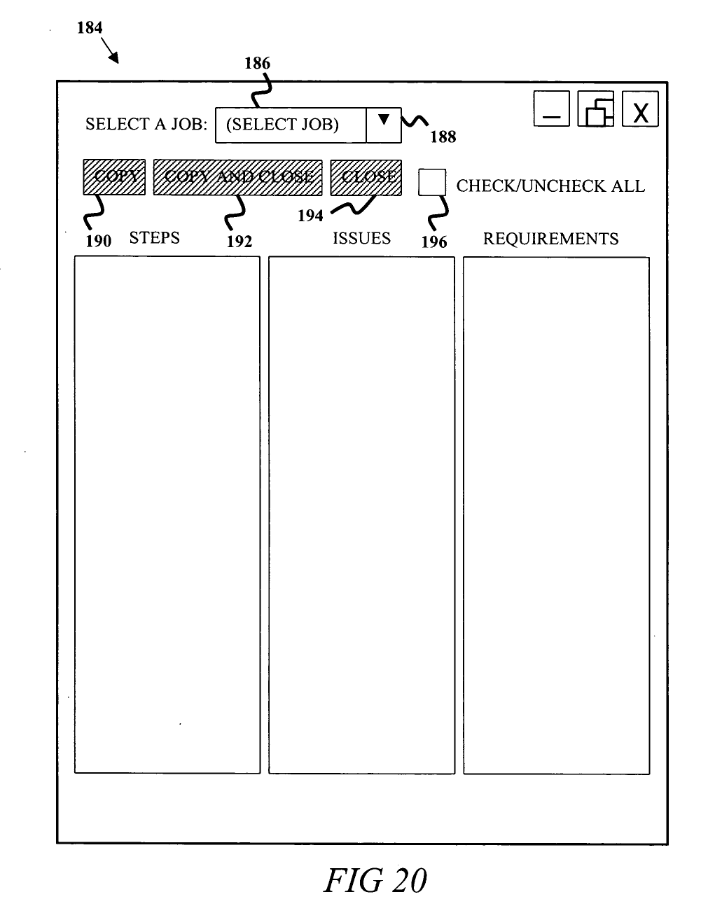

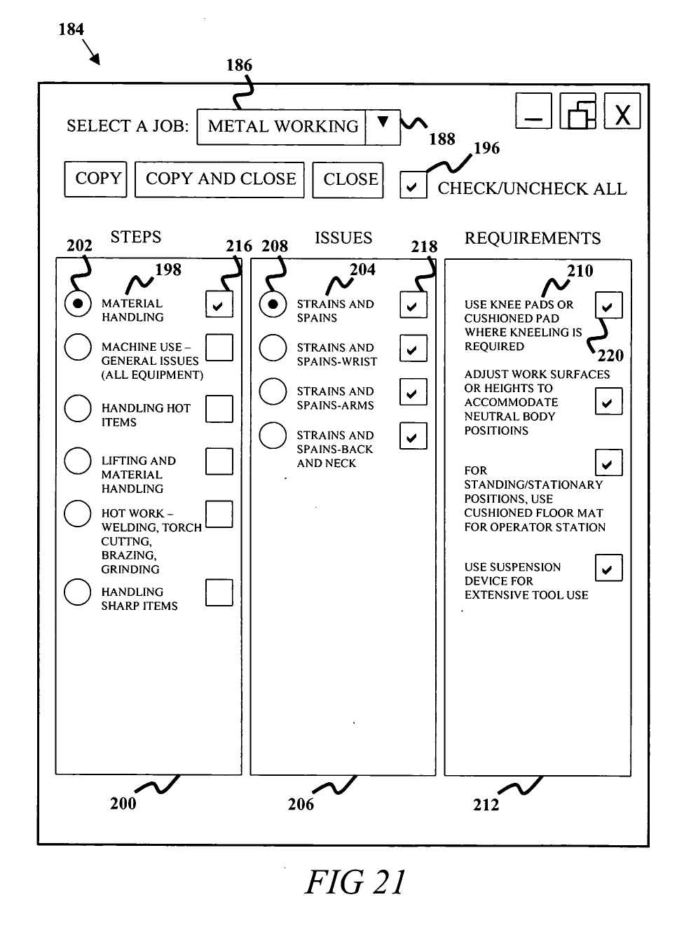

The participant may access pre-defined library job steps, library job issues and library job requirements by selecting the enter library option 56 and displaying a library web page 184, as depicted in FIG. 20. The library web page 184 displays library job names 186 in a library job name drop-down list 188, and temporarily inactive options to copy library selections 190, copy library selections and close 192, and close the library web page 194, where the temporarily inactive options are depicted as having hatch marks to designate as temporarily inactive and remain inactive until a library job name 186 is selected. The library web page 184 allows the participant to access job safety analysis and job safety training and accountability information common to a user group as defined by the user profile established by the administrator of the invention. Further depicted in FIG. 20 is a check/uncheck all box 196 for facilitating in selecting library items. The participant is prompted to select a library job name 186 from the library job name drop-down list 188 whereby the library information associated with the selected library job name 186 is then displayed, as depicted in FIG. 21.

Depicted in FIG. 21, as an example, the participant selects the library job name 186 “METAL WORKING” from the library job name drop-down list 188 to display associated library job steps 198 in a library job step list 200 having library job step activation buttons 202, and displaying library job issues 204 in a library job issue list 206 having library job issue activation buttons 208, and displaying library job requirements 210 in a library job requirement list 212 having library job requirement activation buttons 214. The library items have associated activation buttons, wherein the activation buttons selectively enable/disable the library job steps 198, library job issues 204 and library job requirements 210. A first library job step 198 in the library job step list 200 is enabled by default, having an enabled library job step activation button 202, where only one library job step activation button 202 in the library job steps list 200 may be enabled at one time. Further depicted, a first library job issue 204 in the library job issue list 206 is enabled by default having an enabled library job issue activation button 208, where only one library job issue activation button 208 in the library job issues list 206 may be enabled at one time. Additionally depicted, a first library job requirement 210 in the library job requirement list 212 is enabled by default having an enabled library job requirement activation button 214, where only one library job requirement activation button 214 in the library job requirement list 212 may be enabled at one time.

FIG. 21 further depicts library job step check/uncheck boxes 216, library job issue check/uncheck boxes 218, and library job requirement check/uncheck boxes 220, wherein the check/uncheck boxes selectively enable/disable the library job step 198, library job issue 204, and library job requirement 210 selections for copying from the library to the existing job safety analysis and job training and accountability curriculum web page 112 or new job safety analysis and job training and accountability curriculum web page 78. For convenience, a check all/uncheck all box 196 is provided, wherein activating the check all/uncheck all box 196 enables automated checking and unchecking of the check/uncheck boxes of the activated library job step 198 and the library job issues 204 in the library job issue list 206 associated to the activated library job step 198, and the library job requirements 210 in the library job requirement list 212 associated to the library job issues 204 for automatic selection and copying. Alternatively, the participant may uncheck the check/uncheck all box 196 and manually select from the library items for copying from the library to the existing job safety analysis and job training and accountability curriculum web page 112 or new job safety analysis and job training and accountability curriculum web page 78 by checking the desired library job step check/uncheck boxes 216, the library job issue check/uncheck boxes 218 and/or the library job requirement check/uncheck boxes 220.

FIG. 21 depicts a library job name 186 “METAL WORKING” being selected for illustrative purposes. Depicted here, the check/uncheck all box 196 is checked, or activated, to enable the participant to simply select a desired library job step activation button 202 to select a desired library job step 198 and check the library job step check/uncheck box 216 of the activated library job step 198 to automatically check all the library job issue check/uncheck boxes 218 in the library job issue list 206 associated with the selected library job step 202, and to automatically check all the library job requirement check/uncheck boxes 220 in the library job requirement list 212 associated with the library job issue list associated with the selected library job step 198.

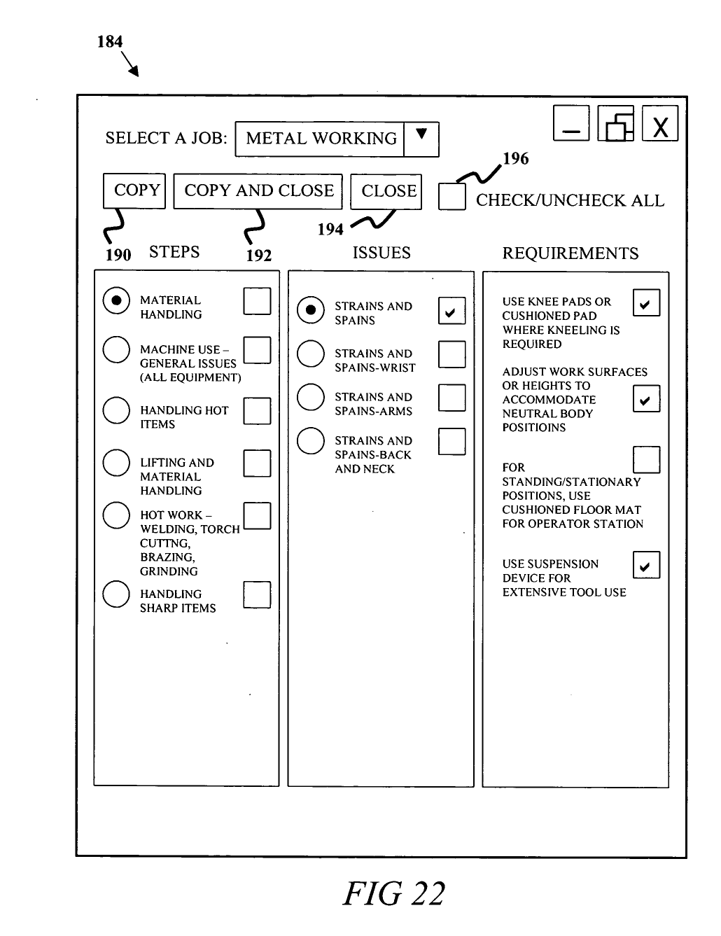

FIG. 22 depicts the library web page 184 having an unchecked check/uncheck all box 196 to enable the participant to manually select items for copying from the library to the existing job safety analysis and job training and accountability curriculum web page 112 or new job safety analysis and job training and accountability curriculum web page 78.

Once the participant has checked the boxes to the desired library job steps 198, library job issues 204, and library job requirements 210 for copying from the library to the existing job safety analysis and job training and accountability curriculum web page 112 or new job safety analysis and job training and accountability curriculum web page 78, the participant may select the copy library option 190, whereby the job safety analysis and job safety training curriculum web page receives the copied data while the participant is viewing the displayed library, enabling further library web page 184 review, selection and copying. Alternatively, the participant may select the copy selections and close library option 192 to copy the selections to the existing job safety analysis and job training and accountability curriculum web page 112 or new job safety analysis and job training and accountability curriculum web page 78 and close the library web page 184. Additionally, the participant may select the close library option 194 to close the library web page 184 and return to the existing job safety analysis and job training and accountability curriculum web page 112 or new job safety analysis and job training and accountability curriculum web page 78 without copying the selections.

In the existing job safety analysis and job safety training and accountability web page 112 of FIG. 16 for example, the participant may elect to save the job to the remote data storage 14 system by selecting the save job option 58 to save the existing job safety analysis and job safety training and accountability curriculum web page 112 to the remote data storage 14 system.

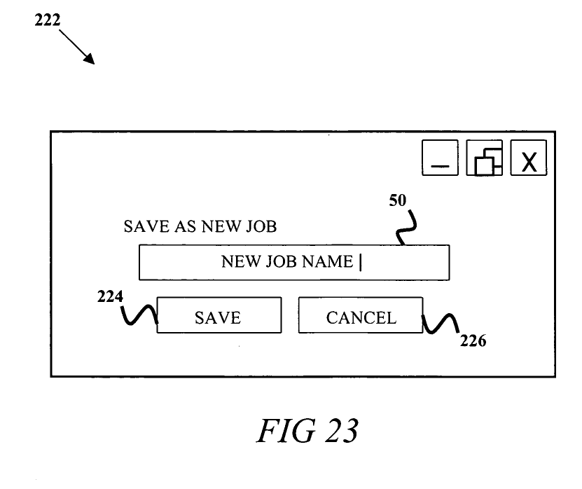

In FIG. 16, the participant may save the job as a new job name by selecting the save job as option 60, whereby the secure web site 18 displays a save job as web page 222, prompting the participant to enter a new job name 50 for display in the job name list 52 as depicted in FIG. 23. The participant may save the job under the new name by selecting an option to accept save as 224, or the participant may cancel the save job as web page 222 by selecting a cancel save as option 226 and return to the existing job analysis and safety training and accountability curriculum web page 112.

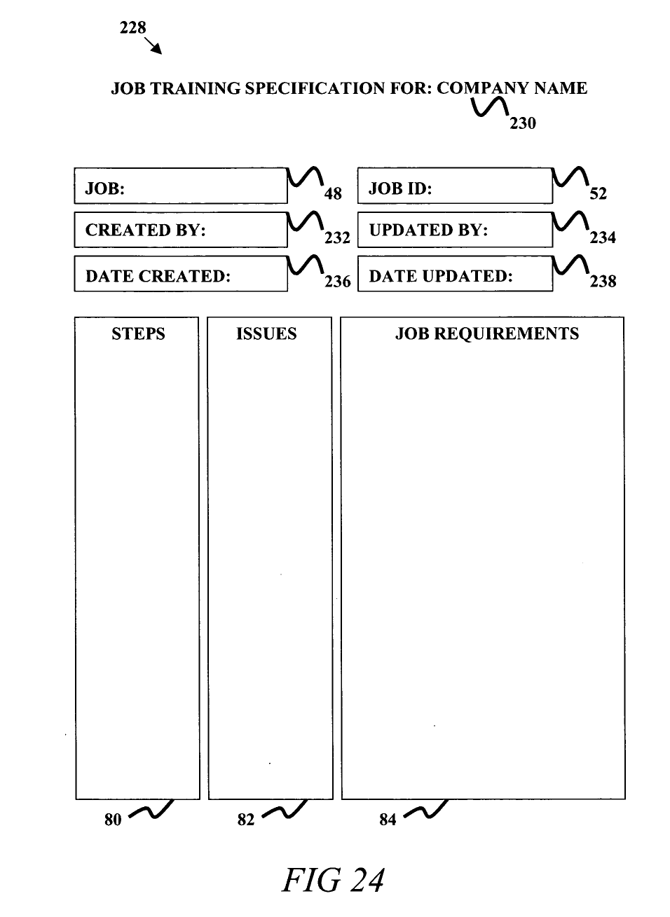

FIG. 24 depicts a job analysis and safety training and accountability specification form 228 resulting from the creation, selection and editing methods described above. The specification form 228 can be access and/or displayed by selecting from the menu options of the job safety analysis and job safety training curriculum options quick view 62 and view/print 64. For purposes of example, the specification form depicted in FIG. 24 displays empty categories for the participant company name 230, created by name 228, updated by name 234, date created name 236, date updated 238, along with the previously discussed items including job name 48, job identification name 52, job steps, job issues and job requirements.

The participant may select the quick view option 64 to displaying a quick view web page of the job analysis and safety training and accountability specification form 228 as depicted in FIG. 24. The display shows the participant company name 230, the job name 48, the job identification name 52, a created by name 232, an updated by name 234, a date created name 236, a date updated 238, the job steps list 80, the job issues list 82 and the job requirements list 84, wherein the quick view web page cannot be modified and is for viewing purposes only.

The participant may select the view/print option 64 to display, as depicted in FIG. 24, a portable data file page of the job analysis and safety training and specification form 228 for viewing and printing having the participant company name 230, the job name 48, the job identification name 52, the created by name 232, the updated by name 234, the date created name 236, the date updated 238, the job steps list 80, the job issues list 82 and the job requirements list 84, wherein the portable data file page cannot be modified and is for viewing and printing.

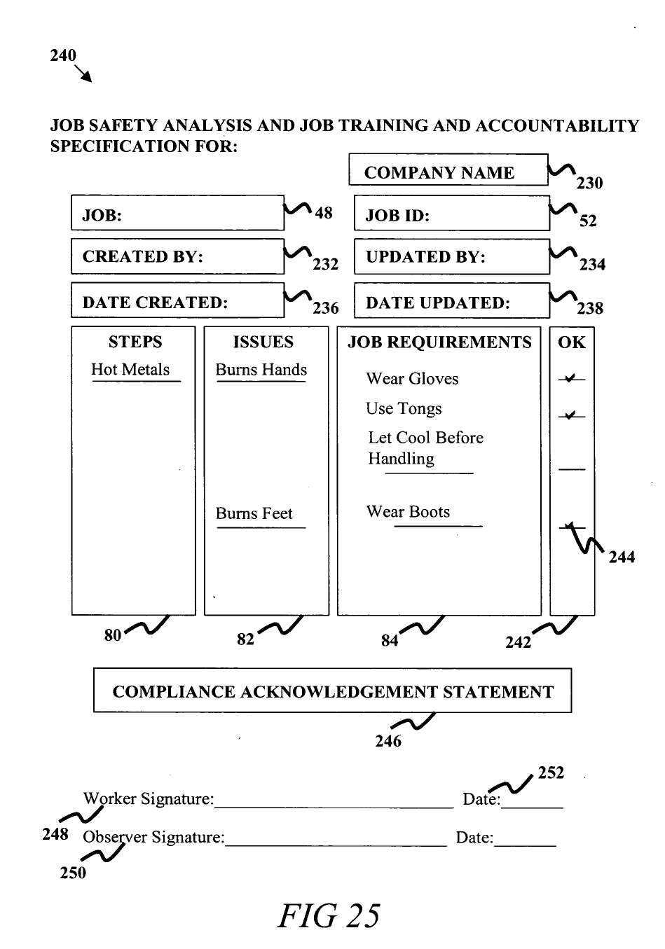

The participant may select the view in word processor document option 68 to display a word processor document page of a safety compliance evaluation and training form 240 depicted in FIG. 25. The word processor document of the safety compliance evaluation and training form 240 having the participant company name 230, the job name 48, the job identification number 52, the created by name 232, the updated by name 234, the date created name 236, the date updated 238, the job steps list 80, the job issues list 82, the job requirements list 84 and a safety compliance verification list 242 comprising compliance acknowledgement marking lines 244 for marking when safety compliance and good safety practice is observed. The safety compliance evaluation and training form 240 may be stored in the remote data storage 14 system for use within a user group. As depicted in FIG. 25, the safety compliance evaluation and training form 240 further comprises a compliance acknowledgement statement 246, a worker signature line 248, an observer signature line 250 and signature dates 252, where a worker and observer acknowledge the accuracy of the evaluation by signing and dating the safety compliance evaluation and training form 240. The word processor document enables the insertion of photos to the safety compliance evaluation and training form 240 to supplement training where the photos may depict proper safety compliance examples. Additionally company logos and other graphics may be inserted to the safety compliance evaluation and training form 240.

Obviously, many modifications and variations of the present invention are possible in light of the above teachings. It is therefore to be understood that, within the scope of the appended claims, the invention may be practiced otherwise than as specifically described.

1. An internet-based job safety analysis and job safety training and accountability method of specifying jobs having job steps and job issues related to performing said job steps and job requirements related to said job issues comprising the steps of:
a. providing a computer and data storage system for operation with said internet; and
b assigning user profiles to a plurality of participants to define user groups, where access parameters comprising usernames and passwords are established for using shared files in said data storage system common to said user groups; and
c. signing a participant onto a predetermined secure web site whereby a log-in web page is displayed prompting said participant to log-in using a user name and a secure password and to select a log-in button to access said job safety training and accountability web site wherein said web site has options to minimize, maximize, reduce and close said web site; and
d. displaying menu options to enable said participant to select there from to create, use, edit, store, access user manual, manage job safety analysis and job safety training and accountability curriculum, log-out, display and print job safety analysis and job training information located on a remote data storage system.
e. providing a customized safety compliance evaluation and training form for printing and use in safety compliance evaluation and training.

2. The method according to claim 1 wherein said safety compliance evaluation and training form comprises a participant company name, a job name, a job identification number, a created by name, an updated by name, a date created, a date updated, a job steps list, a job issues list, a job requirements list, a safety compliance verification list having compliance acknowledgement marking lines for marking when safety compliance and good safety practice is observed; and
a. said safety compliance evaluation and training form is stored in said remote data storage system for use within said user group and further comprises a compliance acknowledgement statement, a worker signature line, an observer signature line and signature dates, where said worker and said observer acknowledge the accuracy of an evaluation by signing and dating said safety compliance evaluation and training form; and
b. said safety compliance evaluation and training form is a word processor document that enables the insertion of photos to said safety compliance evaluation and training form to supplement training, where said photos depict proper safety compliance examples.

3. The method according to claim 1 comprising the steps of selecting said log-out option terminates said access to said job analysis and job safety training and accountability web site; and
a. selecting said access user manual option displays a web page providing user instructions to said participant.

4. The method according to claim 1 comprising the steps of selecting said manage job safety analysis and job training and accountability curriculum option; and
a. displaying a job safety analysis and job training web page having options to return to main menu, log-out, create a new job, select a job name from a job name list having associated job identification numbers, wherein selecting said return to main menu option displays said main menu and selecting said log-out option returns said participant to said log-in web site web page.

5. The method according to claim 4 comprising the steps of selecting said create a new job option; and
a. displaying a create new job web page prompting said participant to enter a new job name and select an add new job name option to enter said new job name to said job name list or select a cancel new job name option to close said add new job name web page, and
b. entering a new job name at said new job name prompt; and
c. selecting said add new job name option wherein a new job name update web page is displayed to verify said new job name being added to said job name list; and
d. displaying a new job safety analysis and job training curriculum on said job safety analysis and job training web page associated to said new job name in said job name list, and options to update job identification name, enter a library, save job, save job as, quick view, view print and view in word processor document, having an empty job step list, an empty job issue list, an empty job requirement list.

6. The method according to claim 5 comprising the steps of selecting said update job identification name option; and,
a. displaying a custom job identification name web page prompting said participant to enter a custom job identification name and select a save custom job identification name option to store said custom job identification name in said remote data storage system or select a cancel custom job identification number option to close said custom job identification number web page, wherein said custom identification number is for use by said participant and does not affect said job identification name location in said data storage system.

7. The method according to claim 4 comprising the steps of selecting said job name from said job name list; and,
a. displaying a job safety analysis and job safety training and accountability curriculum associated with said selected job name comprising a job identification number, a job step list, a job issue list and a job requirement list associated with said job name; and,
b. displaying options to add a new job step to said job step list, add a new job issue to said job issue list, add a new job requirement to said job requirement list, edit said job steps in said job step list, delete said job steps from said job step list, edit said job issues in said job issue list, delete said job issues from said job issue list, edit said job requirements in said job requirement list, delete said job requirements from said job requirement list; and,
c. displaying said job steps in said job step list having job step activation buttons, wherein operating said job step activation buttons selectively enable/disable said job steps where a first job step in said job step list is enabled by default and only one said activation button in said job steps list may be enabled at one time; and,
d. displaying said job issues in said job issue list having job issue activation buttons, wherein said job issues are related to said selected job step and a first job issue in said job issue list is enabled by default where only one activation button in said job issue list may be enabled at one time; and,
e. displaying said job requirement in said job requirement list having job requirement activation buttons, wherein said job requirements are related to said selected job issue and a first job requirement in said job requirement list is enabled by default where only one activation button in said job requirement list may be enabled at one time.

8. The method according to claim 7 comprising the steps of selecting said add new job step option; and,
a. displaying an add new job step web page having an enter new job step prompt for said participant to enter a new job step and record said new job step by selecting an accept new step option to add said new job step to said job step list or enabling said participant to cancel said add new job step web page by selecting a cancel new job step option and close said add new job step web page.

9. The method according to claim 7 comprising the steps of editing said job step, job issues and job requirements; and,
a. selecting said job step activation button to select said job step for an action; and,
b. selecting said edit job step option; and,
c. displaying an edit job step web page having details of said selected job step for editing and prompting said participant to edit said job step details; and,
d. selecting an add edited job step option to display said edited job step in said job step list, or selecting said cancel edit job step option to close said edit job step web page; and,
e. selecting said job issue activation button to select said job issue for an action and selecting said add job issue option to display an enter new job issue web page having an enter new job issue prompt for said participant to enter a new job issue and record said new job issue to said job issue list by selecting an add new issue option, or enabling said participant to cancel add new job issue by selecting a cancel new job issue option and close said enter new job issue web page; and,
f. selecting said job issue activation button to identify said job issue for an action and selecting said edit job issue option and displaying an edit job issue web page having details of said identified job issue for editing and prompting said participant to edit said job issue details and select an add edited job issue option to display said edited job issue in said job issue list, or enabling said participant to cancel edit job issue by selecting a cancel edit job issue option and close said edit job issue web page; and,
g. selecting said job issue activation button to identify said job issue for an action and selecting said delete job issue option to remove said identified job issue from said job issue list; and,
h. selecting said job requirement activation button to select said job issue for an action and selecting said add job requirement option to display an enter new job requirement web page having an enter new job requirement prompt for said participant to enter a new job requirement and record said new job requirement to said job requirement list by selecting an add new requirement option, or enabling said participant to cancel add new job requirement by selecting a cancel new job requirement option and close said enter new job requirement web page; and,
i. selecting said job requirement activation button to identify said job requirement for an action and selecting said edit job requirement option and displaying an edit job requirement web page having details of said identified job requirement for editing and prompting said participant to edit said job requirement details and select an add edited job requirement option to display said edited job requirement in said job requirement list, or enabling said participant to cancel edit job requirement by selecting a cancel edit job requirement option and close said edit job requirement web page.
j. selecting said job requirement activation button to identify said job requirement for an action and selecting said delete job requirement option to remove said identified job requirement from said job requirement list.

10. The method according to claim 5 comprising the steps of selecting said enter a library option and displaying a library web page having library job names in a library job name list, and options to copy selections, copy selections and close, and close said library web page; and,
a. selecting said library job name from said library job name list; and,
b. displaying library job steps having library job step activation buttons, wherein operating said library job step activation buttons selectively enable/disable said library job steps for an action where a first library job step activation button in said library job step list is enabled by default and only one said library job step activation button in said library job steps list may be enabled at one time; and,
c. displaying said library job issues in said library job issue list having library job issue activation buttons, wherein said library job issues are related to said selected library job step and a first library job issue activation button in said library job issue list is enabled by default where only one library job issue activation button in said library job issue list may be enabled at one time; and,
d. displaying said library job requirements in said library job requirements list having library job requirements activation buttons, wherein said library job requirements are related to said selected library job issue and a first library job requirement activation button in said library job requirement list is enabled by default where only one library job requirement activation button in said library job requirement list may be enabled at one time.
e. displaying library job step check/uncheck boxes, library job issue check/uncheck boxes, library job requirement check/uncheck boxes, wherein said check/uncheck boxes selectively enable/disable selections for copying said library job steps, said library job issues and said library job requirements from said library to said job safety analysis and job safety training and accountability curriculum web page when selected; and,
f. displaying a check all/uncheck all box wherein activating said check all/uncheck all box enables automatic selection for copying an activated library job step and all said associated library issues to said activated library job step and all said associated library job requirements associated to said associated library job issues; and,

11. The method according to claim 10 comprising the steps of selecting said copy library option and copying said library job steps, library job issues and library job requirements related to selected check/uncheck boxes of said job safety analysis and job safety training and accountability curriculum; and,
a. selecting said copy selections and close library option to copy said selections to said job analysis and job training curriculum and closing said library web page; and
b. selecting said close library option to close said library web page and return to said job safety analysis and safety training web page without copying said selections.

12. The method according to claim 5 comprising the steps of selecting said save job option to save said job analysis and safety training and accountability curriculum to said remote data storage system having a relational data storage system; and,

13. The method according to claim 5 comprising the steps of selecting said save job as option and displaying a save job as web page; and
a. prompting said participant to enter a new job name; and
b. having an option to save said new job name, whereby selecting said save new job name stores said job safety analysis and job safety training and accountability curriculum web page in said data storage system under said new job name for future use according to said assigned user profiles; and
c. having an option to cancel save job as operation and return to said job analysis and job training curriculum web page and closing said save job as web page; and

14. The method according to claim 5 comprising the steps of selecting said quick view option and displaying a quick view web page in an internet browser of said job analysis and safety training and accountability curriculum having a participant company name, said job name, said job identification number, a created by name, an updated by name, a date created name, a date updated, said job steps list, said job issues list and said job requirements list, wherein said quick view web page cannot be modified.

15. The method according to claim 5 comprising the steps of selecting said view/print option and displaying a portable data file page of said job analysis and safety training and accountability curriculum for viewing and printing having said participant company name, said job name, said job identification number, said created by name, said updated by name, said date created name, said date updated, said job steps list, said job issues list and said job requirements list.

16. The method according to claim 5 comprising the steps of selecting said view in word processor document option and displaying a word processor document page of said job analysis and safety training and accountability curriculum for viewing, editing, saving and printing, having said participant company name, said job name, said job identification number, said created by name, said updated by name, said date created name, said date updated, said job steps list, said job issues list and said job requirements list.
